(19) United States
(12) Patent Application Publication
(10) Pub. No.: US 2023/0172417 A1
(43) Pub. Date: Jun. 8, 2023

(54) SURFACE CLEANUP MACHINE

(71) Applicant: Ryan Treacy, Winter Haven, FL (US)

(72) Inventor: Ryan Treacy, Winter Haven, FL (US)

(21) Appl. No.: 17/844,725

(22) Filed: Jun. 21, 2022

Related U.S. Application Data
(60) Provisional application No. 63/202,776, filed on Jun. 23, 2021.

(51) Int. Cl. A47L 11/40; A47L 11/282; B08B 3/04; B08B 1/02

(52) U.S. Cl. CPC A47L 11/4047; A47L 11/282; A47L 11/4075; A47L 11/4072; A47L 11/4069; A47L 11/4058; B08B 3/041; B08B 1/02

(57) ABSTRACT

A surface cleanup machine that can clean up grout off a surface or a floor is described.

### RELATED APPLICATIONS

This application claims the benefit of U.S. Application No. 63/202,776, titled “Grout Cleanup Floor Machine” and filed on Jun. 23, 2021, which is incorporated herein by reference in its entirety.

### FIELD

Some implementations relate generally to cleanup equipment, and more particularly to a surface cleanup machine for cleaning surfaces, for example, a tile surface cleanup floor machine.

### BACKGROUND

Existing products (e.g., mechanisms and machines) and processes designed for cleaning grout off a surface involve use of a regular sponge or a sponge that is attached to a plastic handle. After cleaning up the grout, the sponge is rinsed in a container with water/fluid to clean the sponge.

There may exist a need for a surface cleanup machine that can clean grout off a surface, e.g., tiles, to give a finished look to the surface along the grout lines. For example, there may be a need for a motorized/non-motorized surface cleanup machine to clean or wipe grout off a surface, e.g., a tile.

### SUMMARY

In some implementations, a surface cleaning machine comprises a belt. The belt can be lined with one or more of sponge, rubber, or foam in some implementations. In some implementations, the surface cleaning machine comprises one or more rollers. In some implementations, the one or more rollers can rotate the belt. The surface cleaning machine comprises a container in some implementations. In some implementations, the container can be attached to a frame and contains a fluid. In some implementations, the surface cleaning machine comprises one or more casters. In some implementations, the one or more casters can be attached to the frame. In some implementations, the surface cleaning machine comprises one or more handlebars. In some implementations, the one or more handlebars can be attached to the frame. In some implementations, the surface cleaning machine can be maneuvered using the one or more handlebars and/or the one of more casters described above.

In some implementations, the surface cleaning machine may comprise one or more belt squeeze rollers. The one or more belt squeeze rollers can squeeze the belt as it passes through the fluid in the container in some implementations. In some implementations, the surface cleaning machine may comprise a tension adjustment bar. The tension adjustment bar can one of reduce or increase tension applied by the one or more belt squeeze rollers to the belt in some implementations. In some implementations, the surface cleaning machine may comprise an adjustable lever. The adjustable lever can one of lower or raise one or more of the one or more casters with respect to a surface in some implementations. The one or more belt squeeze rollers are motorized in some implementations.

In some implementations, the surface cleaning machine may comprise a front grab lift handle and/or a rear grab lift handle. In some implementations, the surface cleaning machine may comprise a twist knob to lock in the handlebars. The surface cleaning machine may comprise at least one of a switch or a button to turn on the motor in some implementations. The surface cleaning machine may further comprise a motor in some implementations. In some implementations, the motor can rotate the one or more rollers. In some implementations, the motor can be powered by one or more of fuel, a battery, or electricity. In some implementations, the belt can be made of one or more of plastic, fiber, rubber, foam, sponge, a natural material, a synthetic material, or suitable material.

In some implementations, a method to clean a surface can include a belt making contact with the surface to be cleaned. The belt can be lined with foam in some implementations. In some implementations, the belt can be rotated in a loop using one or more mechanized rollers. The belt can pass through a container after making contact with the surface to be cleaned in some implementations. In some implementations, the container can hold a fluid, e.g., water or other cleaning fluid. In some implementations, the belt can be squeezed by one or more rollers as the belt passes through the container and the fluid. The one or more mechanized rollers can be powered by a motor in some implementations. The one or more rollers can be powered by a motor in some implementations.

In some implementations, a method to clean a surface may include a belt making contact with the surface to be cleaned. The belt can be lined with sponge in some implementations. In some implementations, the belt can be rotated in a loop using one or more mechanized rollers. In some implementations, the belt can pass through a container after making contact with the surface to be cleaned. The container can hold a fluid, e.g., water or other cleaning fluid, in some implementations. In some implementations, the belt can be squeezed by one or more rollers as the belt passes through the container and the fluid. In some implementations, the one or more mechanized rollers can be powered by a motor. The one or more rollers can be powered by a motor in some implementations.

### BRIEF DESCRIPTION OF THE DRAWINGS

FIG. 1 is a front perspective view of an example surface cleanup machine in accordance with some implementations.

FIG. 2 is a left side perspective view of an example surface cleanup machine in accordance with some implementations.

FIG. 3 is a rear perspective view of an example surface cleanup machine in accordance with some implementations.

FIG. 4 is a right side perspective view of an example surface cleanup machine in accordance with some implementations.

FIG. 5 is a top angle perspective view of an example surface cleanup machine in accordance with some implementations.

FIG. 6 is a left side cutaway perspective view of an example surface cleanup machine in accordance with some implementations.

FIG. 7 is a side perspective view of an example surface cleanup machine in accordance with some implementations.

FIG. 8 is a side perspective view of an example surface cleanup machine in accordance with some implementations.

FIG. 9 is a side cutaway perspective view of an example surface cleanup machine in accordance with some implementations.

### DETAILED DESCRIPTION

In some implementations, a surface cleanup machine comprises a frame having a front end, a left side, a right side, a bottom, and a rear end. In some implementations, the frame has an upper section, a lower section, and a rear frame section. In some implementations, the frame has an opening on the right side and a locking frame latch on the right side to support a front motor compartment. In some implementations, the left side of the frame is part of the front motor compartment. In some implementations, the locking frame latch on the right side, when in an open position, permits a foam/sponge belt to be placed/wrapped around the front motor compartment and through the rear end that holds a water/fluid container. In some implementations, the front motor compartment and the rear end can include one or more rollers that allow the foam/sponge belt to rotate in a cyclical motion. In some implementations, the foam/sponge belt is squeezed between one or more rollers as it passes through the water/fluid container. When the foam/sponge belt is squeezed between the one or more rollers as it passes through the water/fluid container, grout, dirt, and water from the foam/sponge belt pass/enter into the water/fluid and a clean portion of the foam/sponge belt leaves the water/fluid container. In some implementations, the clean portion of the foam/sponge belt passes under the front motor compartment. In some implementations, the pressure that is applied to the foam/sponge belt can be adjusted to increase or decrease the ability of the foam/sponge belt to clean grout off a surface by increasing or decreasing the pressure with which the foam/sponge belt makes contact with the surface.

In some implementations, the one or more rollers can be placed at/near the top of the front motor compartment, at/near the bottom of the front motor compartment, or inside the rear end that supports the water/fluid container. In some implementations, the rollers at/near the bottom of the front motor compartment can be increased in number to enable greater surface/floor coverage to help clean a larger surface/floor area using the foam/sponge belt and/or to vary the pressure that is applied using the foam/sponge belt on the surface/floor to be cleaned. In some implementations, the roller(s) at/near the top of the front motor compartment can include one or more motorized roller(s) to facilitate the dispersion of friction and tension over the foam/sponge belt. In some implementations, the rollers inside the rear end that supports the water/fluid container can include two or more rollers joined under spring pressure to enable rigorous squeezing and thorough rinsing of the foam/sponge belt as it passes through the water/fluid container to render the foam/sponge belt clean for the next cleaning cycle.

In some implementations, casters or wheels at/near the bottom of the rear end of the frame enable the surface cleanup machine to be maneuvered in a forward, a backward, or a circular motion, among other directions. In some implementations, casters or wheels at/near the bottom of the frame in the front motor compartment enable the surface cleanup machine to be maneuvered in a forward or a backward direction. In some implementations, an adjustable lever on the left side of the frame raises or lowers the casters or wheels at/near the bottom of the frame in the front motor compartment to increase or decrease the pressure applied by the foam/sponge belt against the grouted surface/floor.

In some implementations, a removable stem that supports handlebars of the surface cleanup machine slides into the frame of the front motor compartment and is fixed in place by tightening a screw knob. In some implementations, the upper part of the removable stem supports two handles. In some implementations, one of these two handles is a stationary or a fixed handle while the other handle slides into the stationary or fixed handle. In some implementations, the removable stem has adjustable handlebar setting options. In some implementations, the upper part of the removable stem supports an on/off switch/button that powers a motor inside the front motor compartment. In some implementations, the motor turns a sprocket that in turn moves a chain, that in turn rotates a sprocket attached to a roller, that in turn moves the foam/sponge belt and other rollers in the surface cleanup machine. In some implementations, handles are included at the rear and/or front end of the frame of the surface cleanup machine to enable lifting and shifting of the machine from one place to another.

In some implementations, the surface cleanup machine is motorized, where a motor spins one or more rollers that in turn rotate the foam/sponge belt around one or more other rollers. In the process, the foam/sponge belt is rinsed in a container holding water/fluid. When the surface cleanup machine is pulled backwards or pushed forwards by a user, the foam/sponge belt rotates and cleans grout off the surface, leaving a clean surface with a finished look along the grout lines of the surface.

Some implementations include a surface cleanup machine that can be turned on via a switch or a button. When the surface cleanup machine is on, the motor spins one or more rollers to rotate the foam/sponge belt around one or more other rollers as the foam/sponge belt sweeps a surface or floor. When the user maneuvers the surface cleanup machine in a forward, backward, or circular motion, the foam/sponge belt cleans grout off the surface of tiles/stones/pavers/bricks or other surfaces or floor installations that use grouting, leaving clean and smooth grout lines. The surface cleanup machine obviates the back breaking manual work involved in cleaning grout using a sponge and hands.

In some implementations, the foam/sponge belt rotates in a forward direction and picks up grout as the surface cleanup machine moves over grouted areas that need to be cleaned. In some implementations, the foam/sponge belt is rinsed in a water/fluid container that the frame of the surface cleanup machine supports. In some implementations, when the foam/sponge belt is directed into the water/fluid container by one or more directional rollers, the foam/sponge belt is rinsed by/via spring tension rollers that squeeze out the dirt/grout picked up by the foam/sponge belt and release that dirt or grout into the water/fluid container. After the foam/sponge belt passes through the spring tension rollers, the part of the foam/sponge belt that passed through the rollers is clean and once again picks grout off a surface. In some implementations, adjustments can be made via an adjustment lever placed on a side of the surface cleanup machine to apply increased/more or decreased/less pressure on the floor/surface so as to clean up either more or less grout and achieve the desired grouted look on the floor/surface. In some implementations, when the user walks the surface cleanup machine on grouted areas that need to be cleaned up, the user can maneuver the machine in any direction. It will be appreciated that the surface cleanup machine can accommodate several sizes of foam/sponge belts, e.g., a range of belts starting from a 6-inch-wide foam/sponge belt to a 30-inch-wide foam/sponge belt.

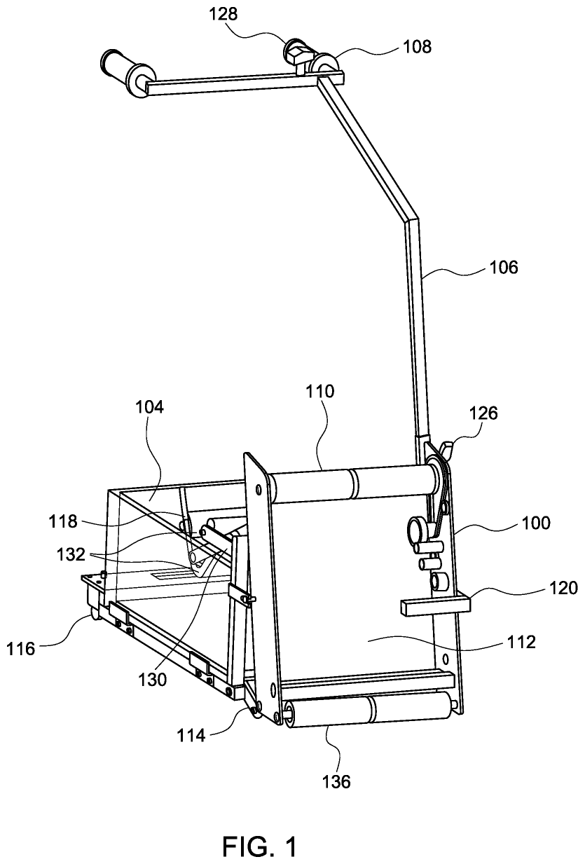

FIG. 1 is a front perspective view of an example surface cleanup machine 100. Handlebars 106 can be added to the surface cleanup machine 100 by sliding the handlebars into a frame 138 of the surface cleanup machine and can be locked into place using a first twist knob 126. The surface cleanup machine 100 can be maneuvered using handlebars 106. An adjustable handlebar mechanism 108 slides in and out of the handlebars 106 and can be locked into place using a second twist knob 128. The surface cleanup machine 100 moves forwards or backwards and turns on casters or wheels 114 and 116, which allow the surface cleanup machine 100 to be maneuvered on the surface or floor.

When the surface cleanup machine is turned on using an on/off switch or a button, a motor in a front compartment 112 turns on a roller 110, which in turn rotates a foam/sponge belt 102. The foam/sponge belt 102 also rolls over a second roller 136 located near the front of the machine. As the foam/sponge belt 102 rotates, the form or the sponge picks up grout off the surface/floor to clean the surface/floor. In some implementations, one or more of rollers 110 or 136 are coated with or made of rubber or a like substance, e.g., a material that facilitates the movement of the foam/sponge belt 102.

A water/fluid container 104 is filled with water or any other fluid that can be used to clean the foam/sponge belt 102. The foam/sponge belt 102 can be squeezed by one or more belt squeeze rollers 132 under spring tension to squeeze out grout/dirt/water picked up by the foam/sponge belt 102 from the surface/floor into the container 104. When the foam/sponge belt 102 passes through the belt squeeze rollers 132, the foam/sponge belt 102 is rinsed clean and freed of the grout, the dirt, and the water. The container 104 can be removed from the surface cleanup machine 100 to empty the dirty water/fluid that can accumulate by cleaning a grouted surface/floor using the surface cleanup machine 100. The container 104 is then replenished and filled with fresh water/fluid. A front grab lift handle 120 at the front end of the surface cleanup machine 100 provides front load lift stability. Also, a lock knob 130 can be used to lock the foam/sponge belt 102 into an operating position when required. A tension adjustment bar 118 can be used to apply the required tension to/on the foam/sponge belt 102.

In some implementations, the foam/sponge belt 102 passes through the belt squeeze rollers 132 before the foam/sponge belt 102 enters the fluid in the container 104. In some implementations, the foam/sponge belt 102 passes through the belt squeeze rollers 132 as the foam/sponge belt 102 passes through the fluid in the container 104. In some implementations, the foam/sponge belt 102 passes through the belt squeeze rollers 132 after the foam/sponge belt 102 passes through the fluid in the container. In some implementations, the belt squeeze rollers 132 are located within the container 104. In some implementations, the belt squeeze rollers are located outside the container 104. In some implementations, the foam/sponge belt 102 passes through the belt squeeze rollers 132 before the foam/sponge belt 102 enters the container 104. In some implementations, the foam/sponge belt 102 passes through the belt squeeze rollers 132 after the foam/sponge belt 102 leaves the container 104.

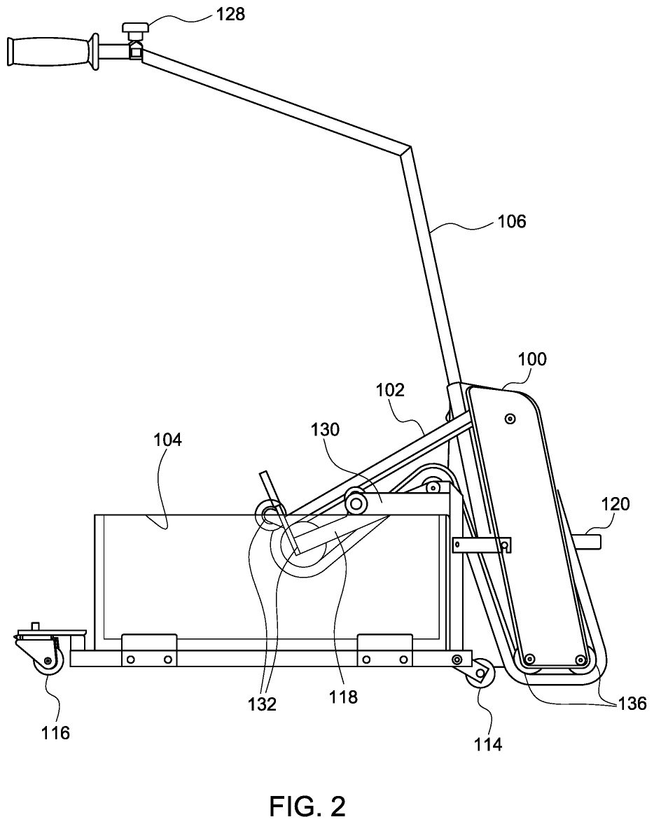

FIG. 2 is a side perspective view of an example surface cleanup machine 100 as displayed.

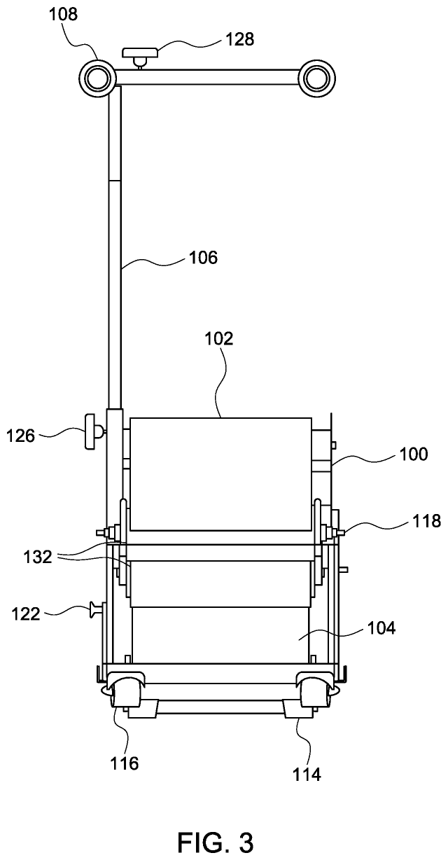

FIG. 3 is a rear perspective view of an example surface cleanup machine 100. FIG. 3 shows the surface cleanup machine 100 with the casters or the wheels 114 and 116 shown more clearly. The casters/wheels 114 and 116 can support the weight of the surface cleanup machine 100. Also, the rear casters/wheels 116 can each swivel up to 180 degrees and also roll backward and forward. The front casters/wheels 114 can only roll backward and forward. The front casters/wheels can be raised up and lowered down by positioning an adjustable lever 122 in a desired setting. The raising or lowering of the front casters/wheels 114 enables a user to increase or decrease the height of the foam/sponge belt 102 relative to the surface or the floor, thereby determining the extent and area of contact made by the foam/sponge belt 102 with and the pressure exerted by the foam/sponge belt 102 on the surface/floor.

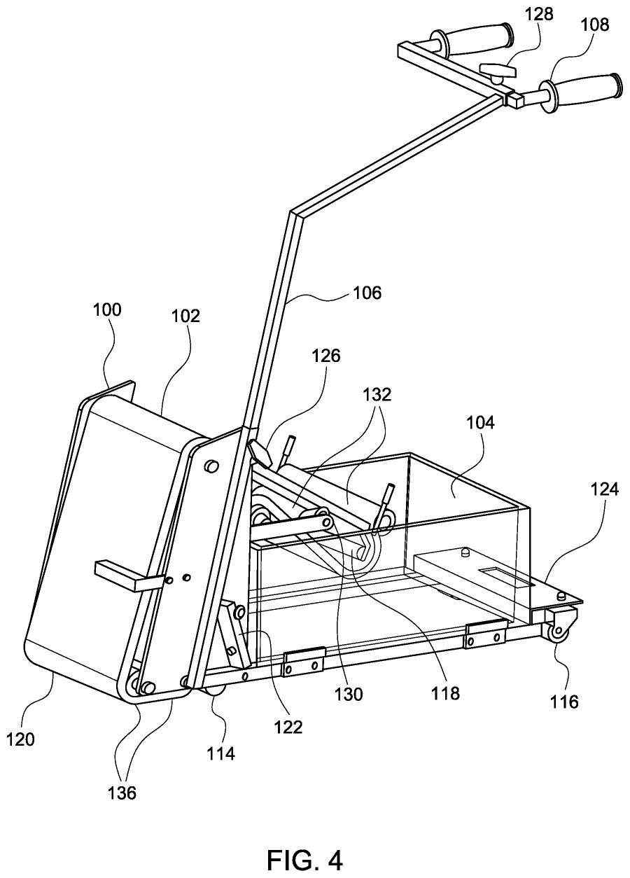

FIG. 4 is a side perspective view of an example surface cleanup machine 100. FIG. 4 shows the foam/sponge belt 102 in an operating position, where the foam/sponge belt 102 is looped through a tension adjustment bar 118, which bar is locked into position when the lock knob 130 is pulled. The foam/sponge belt 102 is squeezed by one or more belt squeeze rollers 132 under spring tension so as to squeeze out grout, dirt, and water into the container 104. When the foam/sponge belt 102 passes through the one or more belt squeeze rollers 132, the foam/sponge belt 102 is rinsed clean and freed of the grout, the dirt, and the water picked up from the surface/floor by the foam/sponge belt 102.

FIG. 4 also shows the front grab lift handle 120 at the front end of a surface cleanup machine 100, which handle provides front load lift stability. FIG. 4 further shows a rear grab lift handle 124 at the rear end of the surface cleanup machine 100, which handle provides rear load lift stability. The front grab lift handle 120 and the rear grab lift handle 124 enable lifting/shifting of the surface cleanup machine 100. FIG. 4 also shows a view of an adjustment lever 122 of the front casters/wheels 114.

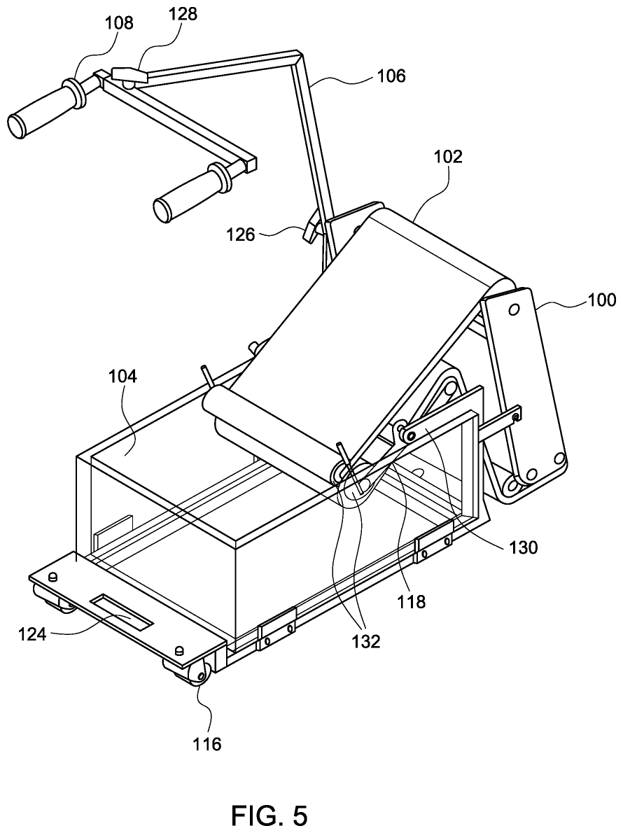

FIG. 5 is a rear perspective view of an example surface cleanup machine 100 as displayed.

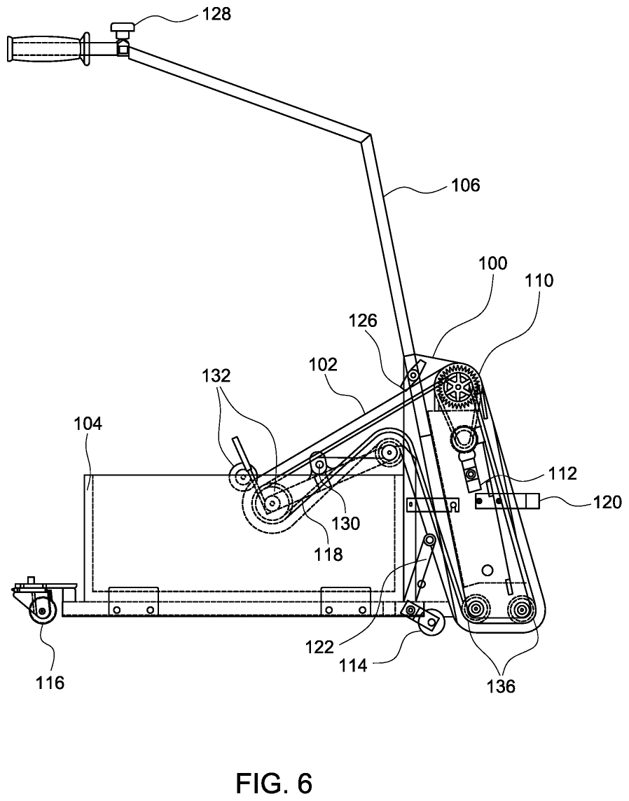

FIG. 6 is a side cutaway perspective view of an example surface cleanup machine 100. FIG. 6 provides a view of the inner working of the surface cleanup machine 100. The front compartment 112 houses the motor, which can be powered by electricity, fuel, or other suitable means. The motor rotates a sprocket attached to the roller 110. The roller 110 in turn grips a liner 134, to which the foam/sponge belt 102 can be affixed by suitable means, e.g., by an adhesive or a mechanical joint. In some implementations, the liner 134 can be made of one or more of plastic, fiber, rubber, or other natural/synthetic material. In some implementations, the belt 102 can also be made of one or more of plastic, fiber, rubber, or other natural/synthetic material, or material similar to foam/sponge/rubber.

Tension can be applied to the liner 134 and/or to the foam/sponge belt 102 by the tension adjustment bar 118, which bar can be locked into position by the lock knob 130. This allows the foam/sponge belt 102 to be turned/rotated so that the foam/sponge belt 102 can be moved across a floor/surface. By applying pressure via the adjustment lever 122, the foam/sponge belt 102 picks up grout/dirt, which is transported by the foam/sponge belt 102 to the container 104. When this grout/dirt reaches the container 104, the grout/dirt can be squeezed out by one or more belt squeeze rollers 132. The belt squeeze rollers are under spring tension due to pressure applied via the tension adjustment bar 118. The grout/dirt can be squeezed into the container 104, leaving a clean foam/sponge belt 102 to repeat the process when a user moves the surface cleanup machine 100 across a surface/floor. This process repeats until the motor is switched off using a switch/button. The motor can be powered by electricity (AC/DC), battery, fuel, a fuel-cell, or any other suitable means. For example, an electric motor can be connected to a 120-volt cable, which can in turn be plugged into an AC power outlet.

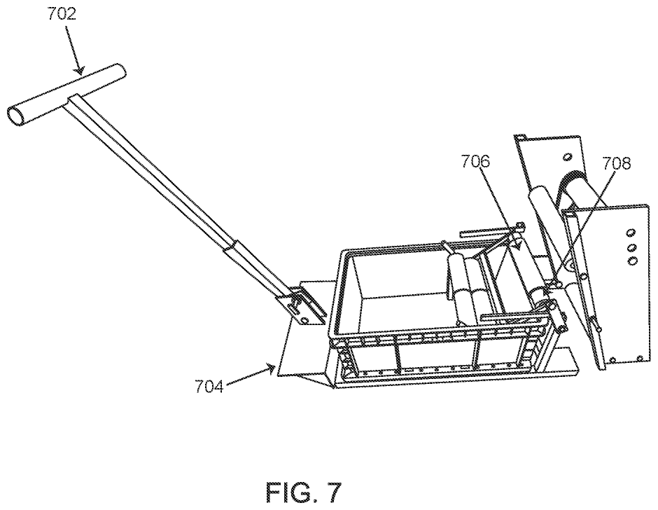

FIG. 7 is a side perspective view of an example surface cleanup machine in accordance with some implementations. FIG. 7 shows a handle 702 of the example surface cleanup machine that is centered on the frame 704 of the example surface cleanup machine. FIG. 7 also shows a foam/sponge belt 706 that is smaller in size compared to the size of the roller 708 over which the belt 706 rotates.

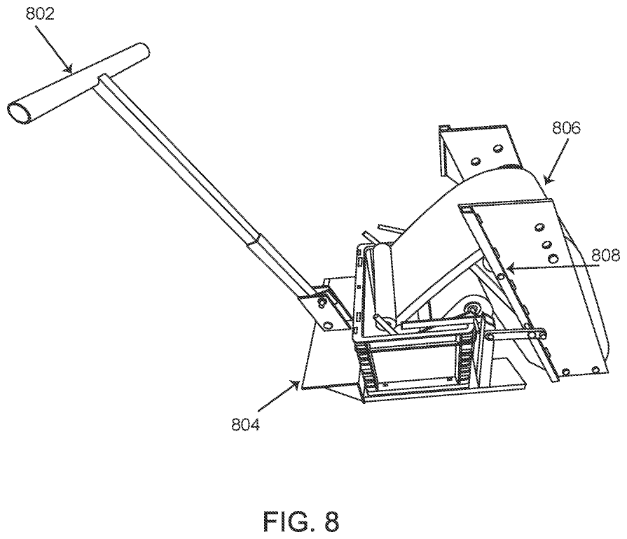

FIG. 8 is a side perspective view of an example surface cleanup machine in accordance with some implementations. FIG. 8 shows a handle 802 of the example surface cleanup machine that is centered on the frame 804 of the example surface cleanup machine. FIG. 8 also shows a foam/sponge belt 806 that is larger in size compared to the size of the roller 808 over which the belt 806 rotates.

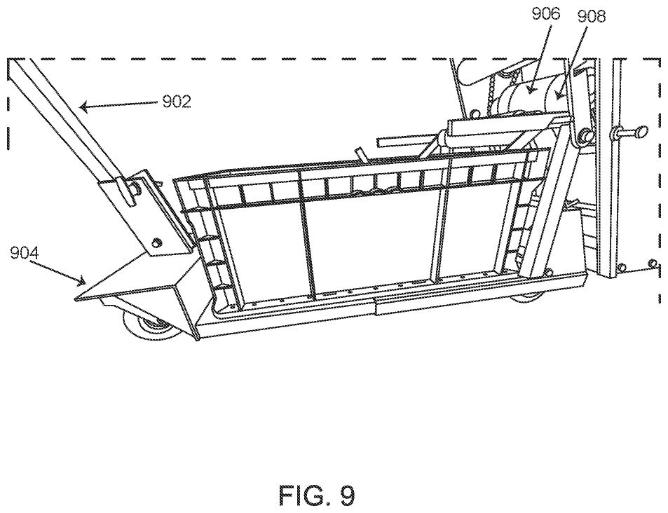

FIG. 9 is a side cutaway perspective view of an example surface cleanup machine in accordance with some implementations. FIG. 9 shows a handle 902 of the example surface cleanup machine that is centered on the frame 904 of the cleanup machine. FIG. 9 also shows a foam/sponge belt 906 that is smaller in size compared to the size of the roller 908 over which the belt 906 rotates.

In some implementations, the size of the foam/sponge belt may be larger than the size of one or more of the rollers over which the belt rotates. In some implementations, the size of the foam/sponge belt may be smaller than the size of one or more of the rollers over which the belt rotates. In some implementations, all of the rollers are of the same size. In some implementations, the rollers are of different sizes. The size of the roller may depend on the type of surface being cleaned.

Some implementations of the surface cleanup machine can include a machine of a size that is close to the width of the foam/sponge belt. This allows for a thorough cleanup of grout along the edges of walls, columns, and railings and renders the machine light-weight, which enables easy maneuverability and transportation of the surface cleanup machine. An implementation of the surface cleanup machine that is as narrow/small as the width of the foam/sponge belt allows the machine to pass through narrow doorways, narrow hallways, small rooms, and closets without any difficulty.

It will be appreciated that the surface cleanup machine can be formed and/or framed in many shapes, including rectangular, cubic or cube-like, cuboidal or cuboid-like, cylindrical, oval, or square shapes. Some implementations can be formed or framed using various suitable materials, including but not limited to plastic composites, PRT or PETE durable thermoplastics, HDPE, PVC, PP, LDPE, carbon fiber, metal, metal alloy, aluminum, copper, steel, brass, fiberglass, resin epoxy, stone, or any other suitable material capable of providing the necessary structural strength and chemical resistance.

It will be appreciated that the removable foam/sponge belt described above is one possible implementation of a foam/sponge belt and is presented for the purpose of illustrating the principles of the disclosed invention. Other removable foam/sponge belt arrangements can be used, including left side or right-side foam/sponge belts, multiple foam/sponge belts side by side, spinning or rotating foam/sponges, separated foam/sponges that can move across/along the surface one after the other, etc.

It will be appreciated that the foam/sponge belt can be made of a suitable material, including plastic, polyester, synthetic polyester, polyurethane, vegetal cellulose, wood pulp, grout sponge or grout sponge 70005q-6d, hemp fiber, carbon fiber, or sodium sulphate crystals. The foam/sponge belt can be located at the front or on the top of the surface cleanup machine in some implementations.

It will be appreciated that the rollers can be made of suitable materials, including plastic, metal, stone, rubber, fiberglass, carbon fiber, or other suitable materials. In some implementations, the rollers are placed at the rear of the machine or at the center of the machine. These rollers rotate the foam/sponge belt in a continuous motion to move the foam/sponge belt from under the front of the machine in contact with the surface and back into the water/fluid container at the rear of the machine.

It will be appreciated that the water/fluid container described above is one implementation of a water/fluid container. Other water/fluid containers can be used, including a bucket, a cylindrical container, a square container, a rectangular container, an oval container, or other suitable containers. The container can be made of any suitable material, including plastic, metal, fiberglass, or carbon.

Some implementations can include a tension mechanism comprising a moving metal arm that pivots about two stationary rod pins located at or near the center of the machine. Under spring tension and assisted by a locking pin or by locking pins, the tension mechanism holds the moving metal arm in position against the foam/sponge belt. In some implementations, the tension mechanism can include a spring (e.g., shock spring), elastic rubber, locking rods, a locking pinrod, among others.

In some implementations, the rollers attached to a tension bar can be made of plastic, rubber, metal, fiberglass, or any other suitable material that can be formed into a cylindrical or similar shape.

In some implementations, the surface cleanup machine has at least two handles. In some implementations, one handle is an L-shaped handle attached to a side of the machine near the front end of the machine. This handle allows the machine to be lifted up and moved to another location. In some implementations, a second handle is included near the rear end of the machine and is cut out of the lower platform bracket or other mechanism that supports the machine or rollers. This handle also allows the machine to be lifted up and moved to another location. In some implementations, handles can be made of plastic, aluminum, metal, rubber, steel, fiberglass, carbon, or other suitable materials.

In some implementations, a lever mechanism is located at or near the left side of the surface cleanup machine to allow the machine to be raised or lowered to different heights. In some of the implementations, the lever can be made of plastic, metal, rubber, fiberglass, or other suitable material.

In some implementations, the surface cleanup machine moves on/over casters/wheels for easy maneuverability of the surface cleanup machine. In some implementations, the casters/wheels can be made of plastic, steel, aluminum, metal, rubber, fiberglass, carbon, or other suitable material.

In some implementations, handlebars can be connected to a metal stem that slides into a frame of the surface cleanup machine and can be tightened in place using a screw knob in some of the implementations. Some implementations can include a handlebar that is stationary and another that slides in and out of the stationary handlebar. In some implementations, the handlebars can be formed in an oval, a rectangular, a square, or a round shape. In some implementations, the handlebars can be made of plastic, steel, aluminum, metal, rubber, fiberglass, carbon, or any other suitable material.

It is therefore apparent that there is provided, in accordance with the various example implementations disclosed herein, a cleanup machine, more specifically, a surface cleanup machine.

What is claimed is:

1. A surface cleaning machine comprising:
a belt, wherein the belt is lined with one or more of sponge, rubber, or foam;
one or more rollers, wherein the one or more rollers rotate the belt;
a container, wherein the container is attached to a frame and contains a fluid;
one or more casters, wherein the one or more casters are attached to the frame;
one or more handlebars, wherein the one or more handlebars are attached to the frame, and wherein the surface cleaning machine is maneuvered using the one or more handlebars and the one of more casters.

2. The surface cleaning machine of claim 1, further comprising one or more belt squeeze rollers.

3. The surface cleaning machine of claim 2, wherein the one or more belt squeeze rollers squeeze the belt as it passes through the fluid in the container.

4. The surface cleaning machine of claim 1, further comprising a tension adjustment bar.

5. The surface cleaning machine of claim 4, wherein the tension adjustment bar one of reduces or increases tension applied by the one or more belt squeeze rollers to the belt.

6. The surface cleaning machine of claim 1, further comprising an adjustable lever.

7. The surface cleaning machine of claim 6, wherein the adjustable lever one of lowers or raises one or more of the one or more casters with respect to a surface.

8. The surface cleaning machine of claim 2, wherein the one or more belt squeeze rollers are motorized.

9. The surface cleaning machine of claim 1, further comprising a front grab lift handle and a rear grab lift handle.

10. The surface cleaning machine of claim 1, further comprising a twist knob to lock in the one or more handlebars.

11. The surface cleaning machine of claim 1, further comprising a motor, wherein the motor rotates the one or more rollers.

12. The surface cleaning machine of claim 11, further comprising at least one of a switch or a button to turn on the motor.

13. The surface cleaning machine of claim 11, wherein the motor is powered by one or more of fuel, a battery, or electricity.

14. The surface cleaning machine of claim 1, wherein the belt is made of one or more of plastic, fiber, rubber, foam, sponge, a natural material, or a synthetic material.

15. A method to clean a surface comprising:
a belt making contact with the surface to be cleaned, wherein the belt is lined with foam;
the belt being rotated in a loop using one or more mechanized rollers;
the belt passing through a container after making contact with the surface to be cleaned, wherein the container holds a fluid; and
the belt being squeezed by one or more rollers as the belt passes through the container and the fluid.

16. The method to clean a surface of claim 15, wherein the one or more mechanized rollers are powered by a motor.

17. The method to clean a surface of claim 15, wherein the one or more rollers are powered by a motor.

18. A method to clean a surface comprising:
a belt making contact with the surface to be cleaned, wherein the belt is lined with sponge;
the belt being rotated in a loop using one or more mechanized rollers;
the belt passing through a container after making contact with the surface to be cleaned, wherein the container holds a fluid; and
the belt being squeezed by one or more rollers as the belt passes through the container and the fluid.

19. The method to clean a surface of claim 18, wherein the one or more mechanized rollers are powered by a motor.

20. The method to clean a surface of claim 18, wherein the one or more rollers are powered by a motor.
